(19) United States
(12) Patent Application Publication
(10) Pub. No.: US 2003/0093451 A1
(43) Pub. Date: May 15, 2003

(54) Reversible arithmetic coding for quantum data compression

(75) Inventors: Isaac Liu Chuang, Prospect, KY (US); Dharmendra Shantilal Modha, San Jose, CA (US)

Correspondence Address: FREDERICK W. GIBB, III, MCGINN & GIBB, PLLC, 2568-A RIVA ROAD, SUITE 304, ANNAPOLIS, MD, 21401, US

(73) Assignee: INTERNATIONAL BUSINESS MACHINES CORPORATION, Armonk, NY

(21) Appl. No.: 09/873,345

(22) Filed: Sep. 21, 2001

(51) Int. Cl. G06F 7/32

(52) U.S. Cl. 708/520

(57) ABSTRACT

A method and structure for encoding/decoding a block of quantum data including removing trailing eigenstates from the block that have eigenvalues below a predetermined limit to retain leading eigenstates that have eigenvalues above the predetermined limit, encoding the remaining quantum bits retained in the block after the removing. The remaining quantum bits can also include a linear superposition of the leading eigenstates. The predetermined limit is based upon a density matrix of the block. This method of encoding produces encoded quantum bits and can further include decoding the encoded quantum bits by reversing the encoding. The decoding reproduces the remaining quantum bits and the encoding completely erases the remaining quantum bits. Further, the invention can include outputting only an encoded or decoded result.

### BACKGROUND OF THE INVENTION

1. Field of the Invention

The present invention generally relates to a method of compressing and decompressing a block of symbols (a block quantum state) emitted by a memoryless quantum Bernoulli source. This presents a simple-to-implement quantum system for projecting, with high probability, the block quantum state onto the typical subspace spanned by the leading eigenstates of the source's density matrix.

2. Description of the Related Art

Computers and information technology electronically transfer large amounts of data. The data could be stored on a computer disk or in the memory of a computer. The data could be transferred from computer to computer via networks, the internet or over the airways. Today's demands on data transfer range from extremely complex items such as satellite photographs, which require a large amount of memory to simpler items such as e-mail text messages, which demand less memory.

Conventional technology performs the data transfer and storage by reducing the data to an electronic charge or bit which is stored in the computer memory, a CD ROM or disk. The bits are assigned data using a binary code, which includes only two values, 0 and 1. Thus, each bit may exist as either a 0 or a 1 and a series of bits may be required to represent each piece of data.

The methodology of this approach to data transfer is derived from classical physics. According to these sciences, modem information theory assumes that an information bit can exist in only one of two states, say, 0 or 1. However, classical physics is known to fail spectacularly under many circumstances, for example, when the objects being described are very small or have very large energies. As a result, conventional information theory fails to properly describe how information may be represented and transformed in such physical systems.

Quantum information theory, which is based on the study of quantum mechanics, is capable of more accurately describing and transferring a wider range of data than the conventional binary code method. Similar to the conventional methods, quantum information theory functions by assigning the data to a series of bits, but the bits are called quantum information bits.

In contrast to the classical information bit, a quantum information bit can exist in a superposition of two orthogonal quantum states. Meaning rather than being limited to one of two states, 1 or 0, a quantum information bit can exist in an infinite number of states. A quantum information bit may be any combination of 0 and 1. For example, it can be 40% 1 and 60% 0.

Quantum information can, in principle, provide significant advantages for certain problems. For example, quantum algorithms for calculating discrete logarithms, see, Shor, (P. W. Shor, Algorithms for quantum computation: Discrete logarithms and factoring,” in Proceedings of the 35th Annual Symposium on Foundations of Computer Science, Santa Fe, New Mexico, (Los Alamitos, Calif.), pp. 124-134, IEEE Computer Society Press, 1994, incorporated herein by reference), and searching unsorted databases, see, Grover, (L. K. Grover, “A fast quantum mechanical algorithm for database search,” in Proceedings of the 28th Annual ACM Symposium on Theory of Computation, Philadelphia, Pa., pp. 212-219, 1996, incorporated herein by reference), have been discovered which are faster than their classical counterparts. Quantum bits, in contrast to classical bits, cannot be copied perfectly, and this is useful in such tasks as quantum cryptography, see, Bennett (C. H. Bennett, G. Brassard, and A. K. Ekert, “Quantum cryptography,” Sci. Am., vol. 267, pp. 50-57, October 1992, incorporated herein by reference). Furthermore, Fuchs (C. Fuchs, “Nonorthogonal quantum states maximize classical information capacity,” Physical Review Letters, vol. 79, pp. 1162-1165, 1997, incorporated herein by reference), has shown that, rather unexpectedly, there exist certain quantum communication channels for which the optimal classical information transmission rate is achieved only using non-orthogonal quantum states as the symbols. Finally, quite surprisingly, quantum error correction codes have been developed, see, Calderbank et al. (A. R. Calderbank, E. M. Rains, P. W. Shor, and N. J. A. Sloane, “Quantum error correction via codes over gf (4),” IEEE Trans. Inform. Theory, vol. 44, pp. 1369-1387, July 1998, incorporated herein by reference) and references therein. Such codes might provide the key technology needed to prevent decoherence of quantum states, and, hence, a way to realize large-scale quantum computing devices. For excellent reviews of the field, see, for example, Bennett and Shor (C. H. Bennett and P. W. Shor, “Quantum information theory,” IEEE Trans. Inform. Theory, vol. 44, pp. 2724-2742, October 1998. Commemorative Issue, 1948-1998, incorporated herein by reference), Rieffel and Polak (E. Rieffel and W. Polak, “An introduction to quantum computing for non-physicists,” http://xxx.lanl.gov/abs/quant-ph/9809016, 1998, incorporated herein by reference) and Steane (A. Steane, “Quantum computing,” Reports on Progress in Physics, vol. 61, pp. 117-173, 1998, incorporated herein by reference).

As our society becomes more modem and more computerized, there is a need to electronically transfer more and more data. To eliminate the limitations of conventional data transfer methods, there is a need for a method of data transfer according to the quantum information theory.

### SUMMARY OF THE INVENTION

It is, therefore, an object of the present invention to provide a structure and method for encoding/decoding a block of quantum data including removing trailing eigenstates from the block that have eigenvalues below a predetermnined limit to retain leading eigenstates that have eigenvalues above the predetermined limit, and encoding the remaining quantum bits retained in the block. The remaining quantum bits can also include a linear superposition of the leading eigenstates. The predetermined limit is based upon a density matrix of the block. This method of encoding produces encoded quantum bits and can further include decoding the encoded quantum bits by reversing the encoding. The decoding reproduces the remaining quantum bits and the encoding completely erases the remaining quantum bits. Further, the invention can include outputting only an encoded or decoded result.

The invention may further include a method for block compression of quantum information which may include projecting a block quantum state into a typical subspace having a plurality of eigenstates, encoding the subspace using an encoder, and decoding the subspace using a decoder which generates the block quantum state using a quantum memoryless Bernoulli source. Projecting of the block quantum state into the typical subspace may include analyzing a plurality of eigenvalues contained in a density matrix associated with the block quantum state, determining a plurality of largest eigenvalues, spanning the subspace wherein the eigenstates are associated with the largest eigenvalues to produce a spanned subspace, and projecting the block quantum state into the spanned subspace to produce a project bloack quantum state that lies in a low dimensional typical subspace. The encoder and decoder are quantum-mechanical inverses of each other and the decoding is achieved by performing the encoding in reverse. The encoding can also include using a fixed-rate quantum Shannon-Fano code to compress the projected block quantum state, wherein compression occurs at a per symbol code rate that is slightly higher than a von Neumann entropy limit. Also, the encoding can include creating a representation quantum Shannon-Fano code as a plurality of quantum arithmetic codes and can use the plurality of quantum arithmetic codes to compress the subspace containing the projected block quantum state.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram of reversible circuits;

FIG. 2 is a flow diagram illustrating a preferred algorithm for encoding data according to the invention;

FIG. 3 is a quantum circuit implementing the flow diagram of FIG. 2;

FIG. 4 is a schematic diagram of a quantum algorithm multiply in which is a classical parameter and B may also be classical, and a schematic circuit symbol for the algorithm;

FIG. 5 is a schematic diagram of a quantum circuit implementing the quantun multiplication algorithm of FIG. 4;

FIG. 6 is a schematic diagram of algorithms “E” and “D”;

FIG. 7 is a schematic diagram of a quantum circuit implementing the block encoder algorithm E in FIG. 6 and a schematic symbol for the circuit;

FIG. 8 is a schematic diagram of a quantum circuit implementing the block decoder algorithm D in FIG. 6 and a schematic symbol for the circuit;

FIG. 9 is a schematic diagram of a quantum circuit implementing the Shannon-Fano encoder, the corresponding decoder being obtained by running the circuit in reverse; and

FIG. 10 is a schematic diagram of a hardware embodiment of the present invention.

### DETAILED DESCRIPTION OF PREFERRED EMBODIMENTS OF THE INVENTION

The statistics underlying a quantum memoryless Bernoulli source is completely captured by the source's density matrix. The fundamental idea behind quantum data compression is to analyze the eigen-structure of the joint density matrix associated with a block quantum state emitted by the quantum memoryless Bernoulli source.

The following contributions are discussed in greater detail below. The invention's first contribution is a quantum-mechanical system for projecting the block quantum state onto the subspace spanned by the most important eigenstates of the joint density matrix, that is, the eigenstates corresponding to the largest eigenvalues.

In other words, the invention removes the having eigenstates below a pre-specified minimum. The remaining eigenstates are the most important and are retained. In one embodiment, the invention evaluates the quantum bits by determining whether they are typical. The invention computes, in parallel, an indicator function that is 0 if the eigenstate is typical and 1 otherwise.

The determination of what is typical is made based upon the density matrix. By making a measurement on the quantum bit associated with the indicator function, with very high probability, the invention projects the block quantum state onto the typical subspace spanned by the leading eigenstates. The invention represents a strengthening of previous results in that the invention holds for fixed block sizes and then delivers a rate of convergence.

The projection onto the typical subspace wipes out the trailing eigenstates, and, hence, the projected quantum state lies in the low-dimensional typical subspace. Thus, the invention reduces the number of different dimensions that must be compressed, making the processing faster and more efficient. Consequently, each leading eigenstate can be represented using roughly the algorithm of the dimension of the typical subspace.

The central problem of quantum data compression is to efficiently compute such low-dimensional representations. The invention also includes a quantum version of the classical Shannon-Fano code to represent and, hence, compress the projected block quantum state using a per symbol code rate that is slightly higher than the von Neumann entropy limit. Conceptually, the invention achieves data compression by dimensionality reduction.

As another contribution, the invention proposes arithmetic codes to efficiently implement quantum Shannon-Fano codes. The invention's arithmetic encoder/decoder uses a certain finite-precision arithmetic process that is inspired by classical arithmetic coding. One point of novelty of the inventive quantum arithmetic coding is the implementation of a finite-precision arithmetic processes in a quantum mechanically reversible fashion. The invention's arithmetic encoder/decoder has a cubic circuit and a cubic computational complexity in the block size. The proposed encoder and decoder are quantum-mechanical inverses of each other, and constitute a very satisfying example of reversible quantum computation.

The first step of the present invention begins by reviewing the definitions of quantum sources and quantum states relevant to the present coding problem. Further, the invention presents precise quantum counterparts for the classical notions of fidelity and entropy, and describes how encoding and decoding is done using quantum computation.

A classical memoryless Bernoulli source emits a sequence of independent and identically distributed symbols each of which is 0 with probability p or 1 with probability 1−p, where 0<p<1. The problem of classical noiseless data compression is the transmitting of sequences of samples emitted by such a source using a minimal number of bits see Shannon, C. E. Shannon, “A mathematical theory of communication,” Bell System Technical J., vol. 27, pp. 379-423, 1948, (incorporated herein by reference) which established that on average each symbol can be transmitted in (slightly larger than) H (p)=−p log p−(1−p) log (1−p) bits with high probability of correct reception, where H (p) is known as the Shannon entropy.

A pure two-dimensional quantum state is known as a quantum bit or qubit. The quantum state of a qubit is mathematically represented by a unit norm vector in a two-dimensional complex vector space (called a Hilbert space) written as H². A qubit may be thought of as a column vector, and is usually written using Dirac's ket notation; for example, |φ> denotes a qubit. The conjugate transpose of |φ> namely, |φ>^{t}, is written in Dirac's braket notation as <φ|. The inner product between an ordered pair of qubits, (φ, φ), is written in Dirac's braket notation as <φ|φ>. The invention writes the fidelity between a pair of qubits, (φ, φ), as <φ|φ><φ|φ>=|<φ|φ>|². Let |φ₀> and |φ₁> denote two arbitrary qubits. A quantum memoryless Bernoulli source emits a sequence of independent and identically distributed symbols each of which is |φ₀> with probability of p or |φ₁> with probability of 1−p, where 0≦p≦1. The per-symbol distribution of this source is described by the density matrix:

ρ=p|φ₀><φ₀|+(1−p)|φ₁><φ₁|, where |φ><φ| denotes the 2×2 matrix given by the outer product between the vector |φ> and its conjugate transpose <φ|.

The problem of (pure state) quantum noiseless data compression is the transmitting of such sequences of symbols with high fidelity, using a minimal number of quantum bits. According to Schumacher's theorem, (B. Schumacher, “Quantum coding,” Physical Review A, vol. 51, pp. 2738-2747, 1995, [11], incorporated herein by reference), on average each symbol can be transmitted in (slightly larger than) S(ρ)=−Tr(ρlog ρ) quantum bits with high probability of correct reception, where S(ρ) is known as the von Neumann entropy. A surprising contrast between the classical and the quantum cases is that S(ρ)≦H(ρ), where the equality is achieved if and only if the quantum states |φ₀> and |φ₁> are orthogonal. Intuitively, this holds since two non-orthogonal qubits cannot be distinguished with certainty by measurement. The invention will let P and E denote the probability and the expectation, respectively, with respect to the quantum memoryless source.

The invention shall focus on compressing a block of η symbols emitted by the quantum source. Let |ψ_{[1,η]}>≡|ψ₁>\mathring{X}|ψ₂>\mathring{X}. . . |ψ_{η}> be a sequence of symbols emitted by the quantum memoryless source, where \mathring{X} denotes the tensor product, and |ψᵢ> represents the ith sample from the source, a random state which is either |φ₀> with probability p or |φ₁> with probability 1−p.

This notation is slightly unconventional. Usually, a quantum state written using the ket notation |·> is definite or pure: it has a von Neumann entropy of zero. However, as shown above, the invention shall find it convenient to use similar notation to denote mixed or random quantum states (random mixtures of pure states); such states will be written with their label in bold, in analogy to the often used classical notation for random variables.

Let χ denote a binary string of length η. The invention will let χ_{[i,j]} denote bits i through j of X. As an alternative to χ_{[l,k]}, the invention may sometimes write ψ_{[k]} to represent the first k significant bits of X. Similar notation, when used with qubits, should be clear by analogy. For example, the invention writes |ψ_{[1,η]}> as |ψ_{[η]}>. For every a>0, the invention writes

$${0}_{a} = {\underbrace{00 ⋯ 0}}_{a times}$$

and

$${1}_{a} = \underbrace{11 ⋯ 1}_{a times} .$$

When it is clear how many zeros or ones are necessary, sometimes the subscript will be suppressed.

Although |φ₀> and |φ₁> may be non-orthogonal, a basis always exists for H₂ in which the same per-symbol distribution source that emits one of two orthogonal states |0> and |1> with probabilities λ₀ and λ₁ (instead of φ₀> and |φ₁> with probabilities p and 1−p). The special basis {|0>,|1>} is defined as follows. The density matrix ρ characterizes the per-symbol distribution of the original quantum Bernoulli source and is self-adjoint, positive-definite, and has unit trace. Hence, its eigenvalues, say, λ₀≧λ₁, are real and nonnegative, and sum to one. If λ₀≈λ₁, choose the states |0> and |1> to be eigenvectors of ρ corresponding to λ₀ and λ₁, respectively. By construction, these states are orthonormal, and form a basis for H². If λ₀=λ₁, the select {|0, |1} to be any orthonormal basis of H². In this basis, the original symbols |φ₀> and |φ₁> are given as |φ₀>=<0|φ₀>|0>+<1|φ₀|1>|φ₁>=<0|φ₁>|0>+<1|φ₁>|1, and the density matrix can be written as ρ=λ₀|0><0|+λ₁|1><1|, where λ₀=1−λ₁=ρ|<0|φ₀>|²+(1−ρ)|<0|φ₁>|².

Furthermore, the invention can now write S(ρ)=H(λ₀).

For 1≦i≦n, the mixed quantum state |ψᵢ> can be written as

|ψᵢ>=<0|ψᵢ>|0>+<1|ψᵢ>|1>,

where <0|ψᵢ> and <1|ψᵢ> are random quantities such that

E|<0|ψᵢ>|²=λ₀ and E|<1|ψᵢ>|²=λ₁. (2)

The sequence of symbols |ψ_{[η]}> in Eq. (1) is a mixed quantum state in the Hilbert

$${H}_{2}^{⊗ η} = {⊗}_{i = 1}^{η} H2 .$$

Using properties of the tensor product, the foregoing can be written as

$$\begin{matrix}\vert {ψ}_{[ η ]} ⟩ = {⊗}_{i = 1}^{η} \vert {ψ}_{i} ⟩ \\ = {⊗}_{i = 1}^{η} {\sum }_{{X}_{i} = 0}^{1} ⟨ {X}_{i} \vert {ψ}_{i} ⟩ \vert {X}_{i} ⟩ \\ = {\sum }_{X ∈ {\{ 0 , 1 \}}^{η}} ⟨ X \vert {ψ}_{[ η ]} ⟩ \vert X ⟩ ,\end{matrix} \qquad ( 3 )$$

where

$$\vert X ⟩ = {⊗}_{i = 1}^{η} \vert {X}_{i} ⟩ \text{and} ⟨ X \vert {ψ}_{[ η ]} = {\prod }_{i = 1}^{η} ⟨ {X}_{i} \vert {ψ}_{i} ⟩ .$$

Now,

$$E {\vert ⟨ X \vert {ψ}_{[ η ]} ⟩ \vert}^{2} {=}^{( a )} {\prod }_{i = 1}^{η} E {\vert ⟨ {X}_{i} \vert {ψ}_{i} ⟩ \vert}^{2} {=}^{( b )} {\prod }_{i = 1}^{η} {λ}_{0}^{( 1 - {X}_{i} )} {λ}_{1}^{{X}_{i}} ≡ Λ ( X ; {λ}_{0} , {λ}_{1} ) , \qquad ( {4}^{′} )$$

where (a) follows from independence and (b) follows from Eq. (2). The 2n quantum state s |X>, Xε{0, 1}ⁿ, can be thought of as the eigenstates of the tensor product density matrix

$${ρ}^{⊗ n} = {⊗}_{i = 1}^{η} ρ ,$$

and the numbers Λ(X; λ₀, λ₁) as the corresponding eigenvalues. Note that the eigenstates |X>, Xε{0, 1}ⁿ constitute an ortionormal basis for the Hilbert space

$${H}_{2}^{⊗ η} .$$

It follows from Eq. (3) that the invention writes the message |ψ_{[n]}> to be encoded as a linear superposition of the 2ⁿ eigenstates (e.g., |X, Xε{0, 1}ⁿ). The “randomness” of the message is completely contained in the coefficients <X|ψ_{[n]}>, and the eigenstates are not a function of the particular message to be transmitted. Physically, the randomness is embedded entirely in the complex amplitude associated with each path or eigenstate.

The encoding and decoding of classical information is specified by a mapping between bit-strings. Similarly, for quantum information, the invention specifies a mapping between quantum states. However, additional reversibility constraints must be satisfied with quantum states. For example, a reversible transformation must conserve energy. Since quantum states are mathematically represented by vectors with unit norm, reversible transformations must preserve the norm. It also turns out that with the appropriate description of the system, the most general transformation preserves orthogonality between states. If the quantum states in

$${H}_{2}^{n}$$

dimensional column vectors, then most general transformations are described by 2ⁿ×2ⁿ unitary matrices acting on the Hilbert space of the quantum states. Again, a unitary matrix is one whose conjugate transpose is its inverse.

This model of computation subsumes classical computation, because mappings between bit-strings can be described as permutation matrices acting on the basis elements of the Hilbert space. Unitary transforms are always invertible or reversible. All irreversible (classical) computation can be made reversible with only a polynomial amount of overhead (see C. H. Bennett, “Logical reversibility of computation,” IBM J. Res. Dev., vol. 17, pp. 525-532, 1973, incorporated herein by reference). However, not all unitary transforms represent reversible classical computation. Not all unitary transforms can be described by permutation matrices. A unitary transform can be completely specified by its action on all the basis elements of a Hilbert space. Transformations which are not permutations take basis elements to superpositions of basis elements; these are at the heart of the speedup of quantum computation and quantum error correction.

Quantum algorithms are generally very difficult to construct, but choosing the eigenstates |X>, Xε{0, 1}ⁿ, as the basis vastly simplifies the descriptions of the inventions encoding and decoding transforms. In this special basis, the invention only employs unitary transformations which are permutations of basis elements to achieve the inventions goal. These transforms shall be applied to input states which are generally in non-classical superpositions of basis elements. As suggested by Deutsch, (D. Deutsch, “Quantum theory, the Church-Turing principle and the universal quantum computer,” Proc. R. Soc. Land. A, col. 400, pp. 97-117, 1985, incorporated herein by reference), it is convenient to think of what happens as being “quantum parallelism”. For an input |φ>=a|0>+b|1>, a computation U produces U|φ>=aU|0>+bU|1>, by linearity. For example, two “classical” computation happen in parallel, one with input |0> and the other with, |1>, with the two computational paths being weighted with complex amplitudes a and b, respectively. Similar observations hold for arbitrarily large states. As long as U is simply a permutation, these different paths never interfere and a coherent quantum state is maintained.

The invention symbolically describes encoding and decoding unitary transforms for quantum information using algorithms which at first glance look very classical, but in reality, are specially constructed to be quantum. Three characteristics make the invention's algorithms quantum-mechanical. First, they are reversible, which is required as previously explained. Second, they completely erase their inputs, which is a necessity because quantum states cannot be cloned (see W. K Wootters and W. H. Zurek, “A single quantum cannot be cloned,” Nature, vol. 299, pp. 802-3, 1982, incorporated herein by reference) and D. Dieks, “Communication by EPR devices,” Physics Letters A vol. 92 (6), pp. 271-272, 1982, incorporated herein by reference), and thus there is no sense to a sender sending a faithfully encoded quantum state elsewhere without erasing their own knowledge of that state in the process. Third, the invention produces no information other than the encoded (or decoded) state, which allows differentiation between computational paths. Producing such entanglement would ruin the superposition which is being encoded, because any potential for obtaining “which path” information implies the existence of a physical measurement which would (at least partially) collapse the superposition state. Fundamentally, this non-disturbance requirement is deeply related to the no-cloning theorem, and it is a subtle, but very important point.

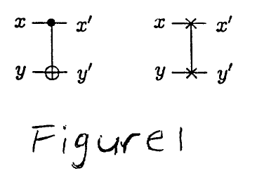

The invention employs for clarity of exposition, quantum circuits, which succinctly capture the same information as the algorithms, and often effectively convey additional structural information about the procedure. A wide body of knowledge about quantum circuits exists (see, A. Barenco, C. H. Bennett, R. Cleve, D. P. DiVicenzo, N. Margolus, P. W. Shor, T. Sleator, J. Smolin, and H. Weinflirther, “Elementary gates for quantum computation,” Physical Review A, vol. 52, no. 5, pp. 3457-3467, 1995, incorporated herein by reference, and A. Barenco, “A universal two-bit gate for quantum computation,” Proc. R. Soc. London A. Vol. 449, no. 1937, pp. 679-683, 1995, incorporated herein by reference), but only the subset shall be drawn from it, which is convenient for describing reversible classical circuits, including the controlled-NOT and swap gates, as shown in FIG. 1.

FIG. 1 illustrates two quantum gates which are used in later quantum circuits. The first gate is the controlled-NOT gate, which produces x′=x and y′=x ⊕ y (⊕denoting (bitwise) addition module 2). The second gate is the swap gate, for which x′=y and y′=x. Time goes from left to right. A final useful notation for expressing the coding procedure is that, given a fractional number (e.g., ζ, 0≦ζ≦1), let ζ=0.ζ₁ζ₂ζ₃ . . . , denote a binary representation of the number. This number can be associated to a pure quantum state |ζ>=|ζ₁>\mathring{X}|ζ₂>\mathring{X}|ζ₃O>\mathring{X} . . . in the infinite-dimensional Hilbert space H

$${H}_{2}^{∞} .$$

This allows for representation of a fractional real number as a quantum state.

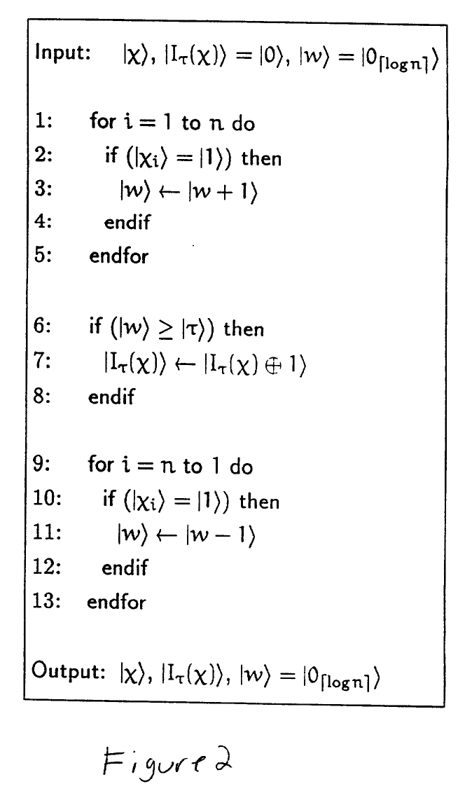

As shown in FIG. 2, a symbolic system or “psuedocode” for computing Eq. (6), discussed below. “←” denotes an assignment operation. When describing a pre-existing state or comparison operation, the invention uses “=”. A temporary quantum register |w> of length [log n] is used. This register is initialized and finalized to |0_{┌log n┐}>. The precise value of τ should satisfy Eq. (8), below and will be specified further below in Eq. (16).

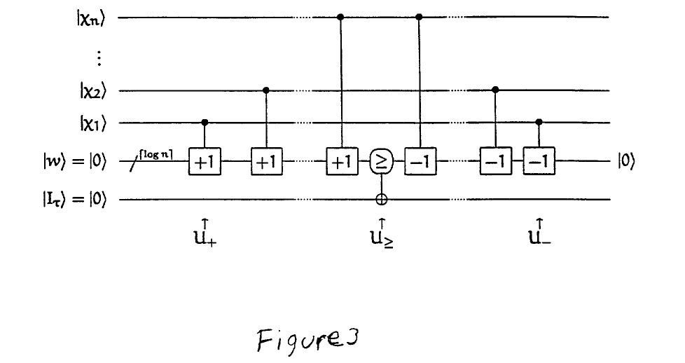

FIG. 3 illustrates a quantum circuit implementing the system in FIG. 2. The gates labeled as U₊ and U₋ implement lines 2-4 and lines 10-12 of the system, respectively. These gates are quantum-mechanical inverses of each other. The gate U_{≧} implements lines 6-8 of the system. As in “Barenco”, supra, the invention generally uses rounded symbols to denote the control qubits, and boxed symbols to indicate the targets, with the exception of “\mathring{X}” which always sits on a target. The /^{┌log n┐} notation indicates a wire bundle with ┌log n┐ qubits. This is proven in the adaption of the technique in Hoeffding (W. Hoeffding, “Probability inequalities for sums of bounded random variables,” American Statistical Association Journal, vol. 58, pp. 13-30, 1963, incorporated herein by reference).

The basic idea of quantum data compression is that the eigenstates associated with smaller eigenvalues can be discarded without incurring significant loss of average fidelity. This goal will be attained by employing a measurement of a certain quantum observable associated with the given message, described further below.

Let w(X), Xε{0, 1}ⁿ, denote the Hamming weight of the string X, for example, the number of ones in the string. It follows from Eq. (4) that it can be written

$$Λ ( X ; {λ}_{0} , {λ}_{1} ) = {λ}_{0}^{η - w ( X )} {λ}_{1}^{w ( X )} \qquad ( 5 )$$

Since λ₀>λ₁, it follows from Eq. (5) that smaller the Hamming weight of an eigenstates the larger the eigenvalue associated with the eigenstate. Let τ≧0 denote a truncation threshold. Let G_{τ} and B_{τ} denote the sets of “good” and “bad” eigenstates such that

G_{τ}={X|w(X)<τ}

B_{τ}={X|w(X)≧τ}.

With appropriate values of τ, the subspace spanned by the good eigenstates, namely,

span{|X>|XεG_{τ}}

becomes the typical subspace that contains most of the information present in an average quantum message.

For every eigenstate |X>, Xε{0, 1}ⁿ, let I_{τ}(X) denote the good-bad indicator function such that

$${I}_{τ} ( X ) = \{ \begin{matrix}0 \text{if} X ∈ {G}_{τ} , \\ 1 \text{if} X ∈ {B}_{τ} .\end{matrix}$$

The following transformation is now computed:

|X,0>→|X,I_{τ}(X)>. (6)

The invention exhibits a quantum system for computing Eq. (6) in FIG. 2, which is implemented by the quantum circuit in FIG. 3. This system makes use of subroutines previously described in the literature (see R. Cleve and D. P. DiVicenzo, “Schumacher's quantum data compression as a quantum computation,” Physical Review A, vol. 54, pp. 2636-2650, October 1996, incorporated herein by reference) for conditional addition and subtraction, and comparison. Using Eq. (3), the action of the system on the quantum message can be written as

$$\vert {ψ}_{[ η ]} , 0 ⟩ \to {\sum }_{X ∈ {\{ 0 , 1 \}}^{η}} ⟨ X \vert {ψ}_{[ η ]} ⟩ \vert X , {I}_{τ} ( X ) ⟩ ≡ \vert {\hat{ψ}}_{[ η ]} , {I}_{τ} ⟩ , \qquad ( 7 )$$

where |\hat{ψ}[η], I_{τ}> is an output state in which I_{τ} is now a function of \hat{ψ}_{[η]} and thus, in general, is entangled with it. Let

$$\{ \vert {I}_{τ} ⟩ {=}^{m} \vert 0 ⟩ \} \text{or} \{ \vert {I}_{τ} ⟩ {=}^{m} \vert 1 ⟩ \}$$

denote the two possible events corresponding to measuring |I_{τ}> to be |0> or |1>, respectively. The truncation threshold τ is determined to ensure that the probability of the event

$$\{ \vert {I}_{τ} ⟩ {=}^{m} \vert 0 ⟩ \}$$

is close to 1.

Assuming that ½<λ₀<1, for a fixed n≧1 and a fixed δ≧0, it is set that

$$τ \geq ⌈ η ( {λ}_{1} + \frac{δ}{log {λ}_{0} / {λ}_{1}} ) ⌉ , \qquad ( 8 )$$

then

$$P \{ \vert {I}_{τ} ⟩ {=}^{m} \vert 0 ⟩ \} = 1 - P \{ \vert {I}_{τ} ⟩ {=}^{m} \vert 1 ⟩ \} \geq 1 - {2}^{\frac{2 n {δ}^{2}}{{( log {λ}_{0} / {λ}_{1} )}^{2}}} . \qquad ( 9 )$$

The invention adapts the technique in Hoeffding (29, W. Hoeffding, “Probability inequalities for sums of bounded random variables,” American Statistical Association Journal, vol.58, pp.13-30, 1963.) incorporated herein by reference:

P{|I_{τ}^{m}|1>}=Σ_{χ}_{^{εBτ}}E|>χ|ψ_{[η]}>|²

$$\begin{matrix}P \{ \vert {I}_{τ} {}^{{m}_{\underline{\_}}} \vert 1 ⟩ \} = {\sum }_{χ ∈ {B}_{τ}} E {\vert ⟨ χ \vert {ψ}_{[ η ]} ⟩ \vert}^{2} \\ {=}^{( a )} {\sum }_{χ ∈ {B}_{τ}} Λ ( χ ; {λ}_{0} , {λ}_{1} ) \\ {\leq }^{( b )} {\sum }_{\{ X \vert - log Λ ( X ; {λ}_{0} , {λ}_{1} ) \geq η ( S ( ρ ) + δ ) \}} Λ ( X , {λ}_{0} , {λ}_{1} ) \\ {\leq }^{( c )} {min}_{γ > 0 [ {\sum }_{\{ X \vert - log Λ ( X ; {λ}_{0} , {λ}_{1} ) \geq η ( S ( ρ ) + δ ) \}} {2}^{γ ( - log Λ ( X ; {λ}_{0} , {λ}_{1} ) - η ( S ( ρ ) + δ ) )} Λ ( χ ; {λ}_{0} , {λ}_{1} ) ]} \\ \leq {min}_{γ > 0 [ {2}^{- γηδ} {\sum }_{χ ∈ {\{ 0 , 1 \}}^{η}} {2}^{γ ( - log Λ ( χ ; {λ}_{0} , {λ}_{1} ) - η S ( ρ ) ) Λ ( χ ; {λ}_{0} , {λ}_{1} )} ]} \\ = {min}_{Y > 0} [ {2}^{- γ η δ} {\prod }_{i = 1}^{η} ( {λ}_{0} {2}^{γ ( - log {λ}_{0} - S ( ρ ) )} + {λ}_{1} {2}^{γ ( - log {λ}_{1} - S ( ρ ) )} ) ] \\ {\leq }^{( d )} {min}_{γ > 0 [ {2}^{- γ η δ {\prod }_{i = 1}^{η} ( {2}^{( 1 / 8 )} {{γ}^{2} ( log ( {λ}_{0} / {λ}_{1} ) )}^{2} )} ]} \\ {=}^{( e )} {2}^{- 2 η {δ}^{2} / {( log ( {λ}_{0} / {λ}_{1} ) )}^{2}}\end{matrix}$$

where (a) follows from Eq. (4); (b) follows since

$${λ}_{1}^{θ} {λ}_{0}^{η - θ} , 0 \leq θ \leq η$$

is a decreasing fuinction of 0, and, hence, by using Eq. (8)

λ₁^{τ}λ₀^{η-τ}≦λ₁^{ηλ}^{₁}^{+ηδ/(log(λ}^{₀}^{/λ}^{₁}⁾⁾λ₀^{η-ηλ}^{₁}^{-ηδ/(log(λ}^{₀}^{/λ}^{₁}⁾⁾

$$\begin{matrix}{λ}_{1}^{τ} {λ}_{0}^{η - τ} \leq {λ}_{1}^{η {λ}_{1} + ηδ / ( log ( {λ}_{0} / {λ}_{1} ) )} {λ}_{0}^{η - η {λ}_{1} - η δ / ( log ( {λ}_{0} / {λ}_{1} ) )} \\ = {λ}_{1}^{η {λ}_{1}} {{λ}_{0}^{η λ0} ( \frac{{λ}_{1}}{{λ}_{0}} )}^{η δ / ( log ( {λ}_{0} / {λ}_{1} ) )} \\ = {2}^{- η ( S ( ρ ) + δ )} .\end{matrix}$$

=2^{-η(s(ρ)+δ)}.

(c) holds for all Y>0, since

2^{γ(-log Λ(χ,λ}^{₀}^{, λ}^{₁}^{)-η(S(ρ)+δ))}≧1;

(d) follows from [W. Hoeffding, “Probability inequalities for sumis of bounded random variables,” American Statistical Association Journal, vol. 58, pp. 13-30, 1963, incorporated herein by reference, (4.16)], if ½<λ₀<1; and (e) follows by selecting the minimizing value

$$γ = \frac{4 δ}{{( log ( {λ}_{0} / {λ}_{1} ) )}^{2}} .$$

Observe that |\hat{ψ}_{[η]}> and |I_{τ}> in Eq. (7) are, in general, entangled. Hence, a measurement on the last qubit will irreversibly effect the first n qubits. Precisely, using yon Neumann's postulate (J. Von Neumann, Mathematical Foundations of Quantum Mechanics. Princeton, USA: Princeton University Press, 1955. Chapter VI), incorporated herein by reference, the effect on |\hat{ψ}_{[η]}> of measuring |I_{τ}> is the following:

$$\vert {\hat{ψ}}_{[ η ]} ⟩ = \{ \begin{matrix}\frac{1}{\sqrt{{\sum }_{χ ∈ {G}_{τ}} {\vert ⟨ χ \vert {ψ}_{[ η ]} ⟩ \vert}^{2}}} {\sum }_{χ ∈ {G}_{τ}} ⟨ χ \vert {ψ}_{[ η ]} ⟩ \vert χ ⟩ \text{if} \{ \vert 0 ⟩ \} \\ \frac{1}{\sqrt{{\sum }_{χ ∈ {B}_{τ}} {\vert ⟨ χ \vert {ψ}_{[ η ]} ⟩ \vert}^{2}}} {\sum }_{χ ∈ {B}_{τ}} ⟨ χ \vert {ψ}_{[ η ]} ⟩ \vert χ ⟩ \text{if} \{ \vert {I}_{τ} ⟩ {=}^{m} \vert 1 ⟩ \} .\end{matrix}$$

In other words, if the event {|I_{τ}>^{m}|0>} occurs, then |\hat{ψ}_{[η]}> will collapse to the renormalized projection of the message |ψ_{[η]}> onto the subspace spanned by the good eigenstates, otherwise |\hat{ψ}_{[η]}> will collapse to the renormalized projection of the message |ψ_{[η]}> onto the subspace spanned by the bad eigenstates. Thus, with high probability, the bad eigenstates are discarded. It follows from Theorem 3.1 that the event {|I_{τ}>^{m}|0>} occurs with very high probability. When this event occurs, the invention now illustrates that, the collapsed state |\hat{ψ}_{[η]}> is not much different from the original message |ψ_{[η]}>, that is, the average fidelity between the two is close to the maximum possible value of 1. Recall that the average fidelity is the probability that the message |\hat{ψ}_{[η]}> passes a test for being the same as the original message |ψ_{[η]}>, whence the test is conducted by someone who knows the original message, see, Schumacher (11, B. Schumacher, “Quantum coding,” Physical Review A, vol. 51, pp. 2738-2747, 1995.) incorporated herein by reference.

If the previous hypotheses holds, then

$$E [ {\vert ⟨ {ψ}_{[ η ]} \vert {\hat{ψ}}_{[ η ]} ⟩ \vert}^{2} \vert \{ \vert {I}_{τ} ⟩ {=}^{m} \vert 0 ⟩ \} ] \geq 1 - {2}^{- \begin{matrix}2 {ηδ}^{2} \\ {( log {λ}_{0} / {λ}_{1} )}^{2}\end{matrix}} .$$

This is shown in the following.

E[|<ψ_{[η]}|\hat{ψ}_{[η]}>|²|{I_{τ}>^{m}|0>}]

$$\begin{matrix}E [ \vert {⟨ {ψ}_{[ η ]} \vert {\hat{ψ}}_{[ η ]} \vert}^{2} \vert \{ {I}_{τ} ⟩ {=}^{m} \vert 0 ⟩ \} ] = E [ \vert {\sum }_{χ ∈ {\{ 0 , 1 \}}^{η}} {\sum }_{ξ ∈ {\{ 0 , 1 \}}^{η}} {⟨ χ \vert {ψ}_{[ η ]} ⟩}^{t} ⟨ ξ \vert {\hat{ψ}}_{[ η ]} ⟩ {⟨ χ \vert ξ \vert}^{2} \vert \{ \vert {I}_{τ} ⟩ {=}^{m} \vert 0 ⟩ \} ] \\ {=}^{( a )} E [ {\vert {\sum }_{χ ∈ {\{ 0 , 1 \}}^{η}} {⟨ χ \vert {ψ}_{[ η ]} ⟩}^{t} ⟨ χ \vert {\hat{ψ}}_{[ η ]} ⟩ \vert}^{2} \vert \{ \vert {I}_{τ} ⟩ {=}^{m} \vert 0 ⟩ \} ] \\ {=}^{( b )} E {\vert \frac{{\sum }_{χ ∈ {G}_{τ}} {\vert ⟨ χ \vert {ψ}_{[ η ]} ⟩ \vert}^{2}}{\sqrt{{\sum }_{χ ∈ {G}_{τ}} {\vert ⟨ χ \vert {ψ}_{[ η ]} ⟩ \vert}^{2}}} \vert}^{2} \\ = E {\sum }_{χ ∈ {G}_{τ}} {\vert ⟨ χ \vert {ψ}_{[ η ]} ⟩ \vert}^{2} \\ {=}^{( c )} {\sum }_{χ ∈ {G}_{τ}} Λ ( χ ; {λ}_{0} , {λ}_{1} ) \\ {=}^{( d )} 1 - {\sum }_{χ ∈ {B}_{τ}} Λ ( χ ; {λ}_{0} , {λ}_{1} ) \\ {\geq }^{( e )} 1 - {2}^{- \frac{2 η {δ}^{2}}{{( log {λ}_{0} / {λ}_{1} )}^{2}}}\end{matrix}$$

where (a) follows by using the orthonormality of the eigenstates; (b) follows from Eq. (10); (c) follows from Eq. (4); (d) follows by applying the binomial theorem to 1=(λ₀+λ₁)^{η}; and (e) follows from the foregoing.

The foregoing, represents a strengthening of Schumacher's pioneering result in that they hold for fixed block sizes and they deliver a rate of convergence.

The invention proposes the following scheme for transmitting the quantum message ψ_{[n]}.

compute Eq. (7)

measure |I_{τ}>

if ({|I_{τ}>^{m}|0>}) then

transmit |\hat{ψ}_{[η]}>

else

do nothing

It follows that the above scheme has high average fidelity with high probability, and only an exponentially small probability of failing to transmit any information. This can be explained as follows: the desirable event ({|I_{τ}>^{m}|0>}) occurs with probability close to 1. And, in the case of this even, only the bad eigenstates are discarded.

From now on, it is assumed that the event ({|I_{τ}>^{m}|0>} has occurred, and the following focuses on transmitting |\hat{ψ}_{[η]}>. It follows from Eq.(10) that |\hat{ψ}_{[η]}> lies in the typical subspace spanned by the good eigenstates. The invention selects the truncation threshold such that the typical subspace has dimension at most 2^{η(S(ρ)+δ)+1} which is much less than the original dimension of 2η. Hence, by appropriately “relabeling” the leading eigenstates, the invention should be able to represent, and, hence, compress the η qubit message |\hat{ψ}_{[η]}> to η(S(ρ)+δ)+1 qubits. The main problem, which is now tackled, is how to compute such a dimensionality reducing or relabeling transformation efficiently.

The eigenvalues λ₀ and λ₁ are real numbers, and, when represented as fractional binary numbers, may require an infinite precision to represent. Since, in practice, the invention can only store and manipulate a finite number of bits, from now on, the invention approximates the eigenvalues using fractional numbers with q significant bits after the binary point. In particular, the invention lets

$${λ}_{0}^{⋄}$$

denote the fractional number obtained by truncating all but the q most significant bits of λ₀. And, the invention lets

$${λ}_{1}^{⋄} = {λ}_{1} + ( {λ}_{0} - {λ}_{0}^{⋄} ) .$$

Since, λ₀+λ₁=1, it follows that

$${λ}_{1}^{⋄}$$

has at most q nonzero significant bits, and the remaining bits must be zeroes. Furthermore,

$${λ}_{0}^{⋄} + {λ}_{1}^{⋄} = 1.$$

In the rest of the disclosure, instead of the original eigenvalues, the invention will use

$${λ}_{0}^{⋄} \text{and} {λ}_{1}^{⋄} .$$

To be sure, such an approximation will slightly increase the per symbol rate needed for compression by

$$D ( {λ}_{0} \vert \vert {λ}_{0}^{⋄} ) = {λ}_{0} log ( {λ}_{0} / {λ}_{0}^{⋄} ) + {λ}_{1} log ( {λ}_{1} / {λ}_{1}^{⋄} ) .$$

The quantity D(•∥•) is known as the relative entropy or as the Kullback-Leibler distance. This increase in the per-symbol rate can be made as small as desired by selecting a large enough q. However, the invention will subsequently demonstrate that the amount of quantum hardware required to implement the encoders and decoders will increase quadratically in q.

The invention now introduces a quantum “encoder” transformation that transforms each eigenstate |χ>, χε{0, 1}^{η}, as follows:

|χ, 0_{ηq}>→|0_{η}, C(χ)>, (12)

where, for a>0, 0ₐ represents a string of a zeroes, and

$$C ( χ ) = {\sum }_{ξ ∈ {\{ 0 , 1 \}}^{η} , ξ ≺ χ} Λ ( ξ ; {λ}_{0}^{⋄} , {λ}_{1}^{⋄} ) ,$$

where Λ

$$Λ ( ξ ; {λ}_{0}^{⋄} , {λ}_{1}^{⋄} )$$

is obtained from Eq. (4) and [symbol] denotes some total order on the strings in {0, 1}ⁿ. The invention will specify a computationally simple-to-implement lexicographical order below. Observe that for every eigenstate |χ>, C(χ) is a number in the real interval (0, 1). Hence, given C(χ), the invention writes |C(χ)> using the terminology of Section 2.5. Intuitively, C(χ) is the sum of the eigenvalues of all eigenstates of length n that are less than or equal to the χ in the total order [symbol] . Since C(X) is a monotonically increasing function of the eigenstates arranged in lexicographical order, it is uniquely decodable. In other words, the transformation

|0_{η},C(χ)>→|χ,0_{ηq}>, (14)

exists for every eigenstate |χ>, χε{0, 1}^{η}. Hence, Eq. (12) is reversible, and can be implemented as an unitary transformation.

Each eigenvalue in the sum Eq. (13) is a product of n numbers each of which has a precision of q bits. Hence, each eigenvalue can be written as a fractional binary number with at most nq nonzero significant bits. Finally, this implies that, for each eigenstate, the number C(X) has precision no more than nq bits. In other words, the encoder is a unitary transformation from

$${H}_{2}^{⊗ η}$$

to a 2ⁿ-dimensional subspace of

$${H}_{2}^{⊗ η q} .$$

However, since generally q>1, this hardly constitutes data compression. The invention now achieves compression by truncating a large number of nonsignificant bits of C(χ).

For a given truncation parameter k≧0 and a given eigenstate |χ>, χε{0, 1}^{η} the invention defines the truncated encoder transform as

|χ,0_{ηq}>→|0_{η}, C(χ)_{[k]}1_{ηq-k>,} Eq. (15)

where C(χ)_{[k]}, denotes the truncation of C(χ) to the k most significant qubits. Observe that only the first k qubits on the right-hand side depend upon the eigenstates, and, hence, only these bits need be transmitted. All the information present in the eigenstate χ has been captured into C(χ) in a reversible fashion. Hence, compression does not cause any loss of information.

Consequently, the encoder in Eq. (15) maps messages of a fixed-length n to codewords of fixed-length k. In other words, the encoder is a unitary transformation from

$${H}_{2}^{⊗ η}$$

to a subspace of

$${H}_{2}^{⊗ k} .$$

The decodability of the untruncated map in Eq. (12) is immediate from the fact that C(χ) is a monotonically increasing function of the eigenstates arranged in the lexicographical order. In contrast, the decodability of the truncated map in Eq. (15) is a delicate matter. If k<n, then the truncated map cannot hope to correctly decode all the eigenstates. However, fortunately, the invention only needs to correctly decode the good eigenstates. The invention can discard the bad eigenstates, since we have assumed that the event ({|I_{τ}>^{m}|0>}) has occurred, and in this case, bad eigenstates have already been discarded. So, there was no need to either encode or decode the bad eigenstates.

The invention now establishes that if the threshold parameter τ and truncation parameter k are carefully selected, then inverse of Eq. (15) exists for all the good eigenstates.

If,

$$\begin{matrix}τ = ⌈ η ( {λ}_{1} + \frac{δ}{log {λ}_{0} / {λ}_{1}} ) ⌉ , & ( 16 ) \\ k \geq η S ( ρ ) + η D ( {λ}_{0} \vert \vert {λ}_{0}^{⋄} ) + η δ + log ( {λ}_{0} / {λ}_{1} ) . & ( 17 )\end{matrix}$$

Then, there exists a decoder such that, for every X in G^{τ},

|0_{η},C(χ)_{[k]}1_{ηq-k}>→|χ,0_{ηq}>. (18)

This is shown inthe following. Given the encoding |C(χ)_{[k]}1_{ηq-k}> of the eigenstate |χ>, the invention defines the corresponding decoded or reconstructed elgenstate as |\tilde{χ}>, \tilde{χ}ε{0, 1}^{η}, that satisfies the following two inequalities:

$$\begin{matrix}C ( \tilde{χ} ) \leq {C ( χ )}_{[ k ]} + {\sum }_{i = k + 1}^{η q} {2}^{- i} & \text{Eq. (19)} \\ {C ( χ )}_{[ k ]} + {\sum }_{i = k + 1}^{η q} {2}^{- 1} < C ( \tilde{χ} ) + Λ ( \tilde{χ} ; {λ}_{0}^{⋄} , {λ}_{1}^{⋄} ) . & \text{Eq. (20)}\end{matrix}$$

In general, owing to truncation, the decoded eigenstate \tilde{χ} need not equal the original eigenstate X. The invention now shows that for values of τ as in Eq. (16), for values of k as in Eq. (17), and for all good eigenstates, the inequalities Eq. (19) and Eq. (20) are satisfied if and only if \tilde{χ}=χ. Suppose that \tilde{χ}=χ. In this case, the first inequality Eq. (19) is trivial, and holds for all X in {0, 1}ⁿ. Now, observe that the second inequality Eq. (20) holds if

$$Λ ( \tilde{χ} ; {λ}_{0}^{⋄} , {λ}_{1}^{⋄} ) = Λ ( χ ; {λ}_{0}^{⋄} , {λ}_{1}^{⋄} ) \geq {2}^{- k} > {\sum }_{i = k + 1}^{η q} {2}^{- i} .$$

It follows from Eq. (4) that the second inequality Eq. (20) holds if

$${( {λ}_{1}^{⋄} )}^{w ( χ )} {( {λ}_{0}^{⋄} )}^{η - w ( χ )} \geq {2}^{- k} .$$

The invention would like the above inequality to hold for all good eigenstates. Since

$${( {λ}_{1}^{⋄} )}^{θ} {( {λ}_{0}^{⋄} )}^{η - θ} , 0 \leq θ \leq η , ,$$

is a decreasing function of θ, it is sufficient that the above inequality holds for the good eigenstates corresponding to the smallest good eigenvalue. If the invention selects τ as in Eq. (16), then the smallest eigenvalue is larger than

$${( {λ}_{1}^{⋄} )}^{τ} {( {λ}_{0}^{⋄} )}^{η - τ} .$$

Hence, the invention requires that

$${( {λ}_{1}^{⋄} )}^{τ} {( {λ}_{0}^{⋄} )}^{η - τ} \geq {2}^{- k} .$$

Equivalently, the invention requires that

$${( {λ}_{1}^{⋄} )}^{τ} {( {λ}_{0}^{⋄} )}^{η - τ} {( \frac{{λ}_{1}^{⋄}}{{λ}_{1}} )}^{τ} {( \frac{{λ}_{0}^{⋄}}{{λ}_{0}} )}^{η - τ} \geq {2}^{- k} .$$

It follows from simple algebraic manipulations that the above holds if

$$k \geq η S ( ρ ) + η D ( {λ}_{0} \vert \vert {λ}_{0}^{⋄} ) + η δ + log ( {λ}_{0} / {λ}_{1} ) .$$

This is exactly the requirement in Eq. (17).

The invention now establishes the converse, that is, if χ≠\tilde{χ}, then both Eq. (19) and Eq. (20) do not hold. There are two cases: either χ [symbol] \tilde{χ} or \tilde{χ} [symbol] χ. In the former case, Eq. (19) cannot hold and in the latter case Eq. (20) cannot hold.

Observe that the desired encoder transform in Eq. (15) annihilates the quantum state X. This is necessary since both |χ> and |C(χ)_{[k]}> contain the same information, and since quantum states cannot be cloned, it is impossible to faithfully transmit weighted superpositions of different |χ> without the sender obliterating her knowledge about it in the process of transforming the state into a weighted superposition of |C(χ)_{[k]}>.

Observe that the untruncated map in Eq. (12) and the truncated map in Eq. (15) map one eigenstate to one encoded state. Hence, they can be thought of as unitary transforms that are permutations of the basis states.

So far, the invention has specified the desired encoder Eq. (15) and the corresponding decoder in Eq. (18) in terms of the eigenstates alone. For the sake of completeness, by using linearity of the encoder and the decoder, the invention now describes their action on the quantum message of interest:

$$\begin{matrix}\vert {\hat{ψ}}_{[ η ]} , {0}_{η q} ⟩ = {\sum }_{χ ∈ {G}_{τ}} ⟨ χ \vert {\hat{ψ}}_{[ η ]} ⟩ \vert χ , {0}_{η q} ⟩ \\ {\to }^{ encode } {\sum }_{χ ∈ {G}_{τ}} ⟨ χ \vert {\hat{ψ}}_{[ η ]} ⟩ \vert {0}_{η} , {C ( χ )}_{[ k ]} {1}_{η q - k} ⟩ \\ {\to }^{ transmit } {\sum }_{χ ∈ {G}_{τ}} ⟨ χ \vert {\hat{ψ}}_{[ η ]} ⟩ \vert {C ( χ )}_{[ k ]} ⟩ \\ {\to }^{ prepare } {\sum }_{χ ∈ {G}_{τ}} ⟨ χ \vert {\hat{ψ}}_{[ η ]} ⟩ \vert {0}_{η} , {C ( χ )}_{[ k ]} {1}_{η q - k} ⟩ \\ {\to }^{ decode } {\sum }_{χ ∈ {G}_{τ}} ⟨ χ \vert {\hat{ψ}}_{[ η ]} ⟩ \vert χ , {0}_{η q} ⟩ \\ = \vert {\hat{ψ}}_{[ η ]} , {0}_{η q} ⟩ ,\end{matrix}$$

where the invention has implicitly used the fact that a measurement on the qubit |I_{τ}> has been made, and the event {|I_{τ}>^{m}|0>} has occurred. The foregoing series of equations capture the essence of the invention. The eigenstates are encoded, transmitted, and decoded without any loss of information. Conceptually, encoding and decoding are reversible operations that are conceptual inverses of each other, hence, no information is lost in the entire process.

The invention now proposes quantum algorithms and associated quantum circuits to efficiently realize the encoder in Eq. (15) and the corresponding Addecoder in Eq. (18).

First, the invention considers the computation of the function C(χ) in Eq. (13). A straightforward algorithm for computing C(χ) by explicitly performing the summation would require an exponential amount of complexity in the block size n. One of the main contributions of classical arithmetic coding is to observe that if the invention selects the total order [symbol] in Eq. (13) to be the following lexicographical order, then the function C(χ) can be efficiently computed. If ξ≡ξ₁ξ₂ . . . ξ_{η}, and χ≡χ₁χ₂ . . . χ_{η} are in {0,1}ⁿ then the invention says that ξ [symbol] χ if and only if

$${\sum }_{i = 1}^{η} {ξ}_{i} {2}^{i - 1} < {\sum }_{i = 1}^{η} χ {i}^{{2}^{i - 1}} .$$

Under this definition of the total order [symbol] the invention can write the function C(χ) recursively as follows, see, [J. Rissanen et al., supra, (1)]:

C(χ)=0

for i=1 to n do

if (Xi=0)

$$C ( X ) = C ( X ) \times {λ}_{0}^{◇}$$

$$else$$

$$C ( χ ) = C ( χ ) \times {λ}_{1}^{◇} + {λ}_{0}^{◇}$$

end if

end for

Instead of the lexicographical order in Eq. (21), the invention can also use the following dual order. If ξ≡ξ₁ξ₂ . . . ξ_{η} and χ≡χ₁χ₂ . . . χ_{η} are in {0, 1}ⁿ, then the invention says that

$$ξ {≺}^{dual} χ \text{if and only if} {{\sum }_{i = 1}}^{η} {ξ}_{i} {2}^{- i + 1} < {\sum }_{i = 1}^{η} {χ}_{i} {2}^{- i + 1} .$$

Under this dual definition, the invention can also write the function C(χ) recursively, see, (Rissanen et al., supra, (2)). Although both the recursions are amenable to a quantum implementation, the recursion corresponding to the total order in Eq. (2 1) turns out to slightly simpler and, hence, is used in this disclosure.

Important parts of the encoding and decoding algorithms are multiplication and division, respectively, and in order to build the quantum coders, the invention must first construct quantum algorithms for such arithmetic. Suitable addition and subtraction circuits have already been described in the literature (D. Beckman, A. N. Chari, S. Devabhaktuni, and J. Preskill, “Efficient networks for quantum factoring,” Physical Review A, vol. 54, no. 2, pp. 1034-1063, 1996, http://xxx.lanl.gov/abs/quant-ph/9602016, and R. Cleve and D. P. DiVincenzo, “Schumacher's quantum data compression as a quantum computation,” Physical Review A, vol. 54, pp. 2636-2650, October 1996, each incorporated herein by reference), but appropriate multiplication and division algorithms have not been. These are described below.

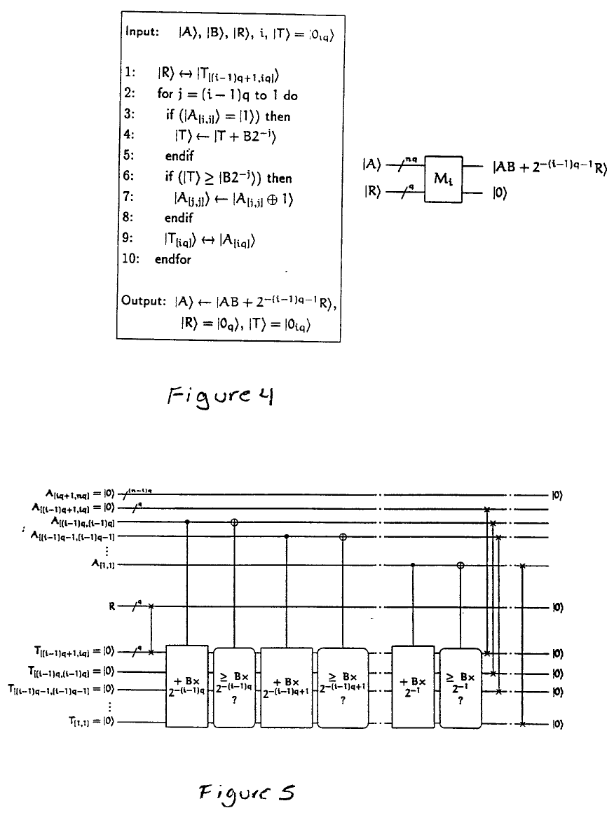

The invention presents in FIG. 4 an algorithm to multiply (A>, B>, R>, i) that takes the following inputs: (a) a fixed index i, i=1, 2, . . . , n, (b) nq qubit register |A> such that all but the first (i−1) q qubits are zeroes, (c) q qubit register |B>, and (d) q qubit register |R>. The algorithm also requires a nq qubit temporary register |T> that is initialized and finalized to |0_{ηq}>. The algorithm computes |A, R>→|A B+2^{-(i-1)q-1} R, 0_{q}>, where multiplications and additions are to be interpreted by treating A, B, and R as fractional binary numbers. A quantum circuit which implements the algorithm is shown in FIG. 5. The steps in FIG. 4 correspond simply to a quantum version of the classical algorithm for multiplying two numbers A and B where there is an additional quantity that is added at the end.

The invention terms the conjugate inverse of this algorithm as divide (|A>, |B>, |R>, i) Given a nq qubit register |A> such that all but the first iq qubits are zeroes, a q qubit register |B> and a q qubit register |R> that is initialized to |0_{q}>, the circuit divide (|A>, |B>, |R>, i) uses a nq qubit temporary register |T> that is initialized and finalized to |0_{ηq}> and divides A by B up to the first (i−1)q bits, and stores the quotient also in A, and keeps the q qubit remainder in R.

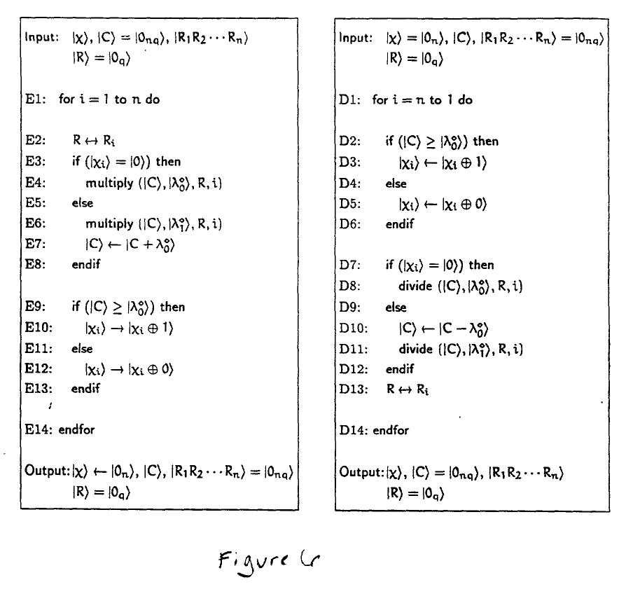

The invention now uses the ideas from arithmetic recursions, and the above circuits for multiplication and division to construct building blocks for the desired encoder in Eq. (15). In FIG. 6, the invention presents two recursive algorithms “E” and “D.” Formally and literally, these algorithms are inverses of each other: lines E2-E8 are literal inverses of lines D7-D13, lines E9-E13 are literal inverses of lines D2-D6, and, finally, the for loop in the algorithm E processes the message symbols in the original order from 1 to n while the for loop in the algorithm D emits the message symbols in the inverse order from n to 1. The invention exhibits quantum circuits for implementing the algorithms E and D in FIGS. 7 and 8, respectively. Observe that these circuits are also quantum-mechanical inverses of each other.

The invention intends to use the algorithms E and D with two different sets of inputs. The invention now explains the functionality of these algorithms on the first set of inputs.

Let |χ>, χε{0, 1}^{η}, denote any eigenstate. The algorithms D and E, respectively, compute the following maps:

D₁:|0_{η},C(χ),0_{ηq}>→|χ,0_{ηq},0_{ηq}>, Eq. (23)

E₁:|χ,0_{ηq},0_{ηq}>→|0_{η},C(χ),0_{ηq}> Eq. (24)

With the inputs as above, E₁ is a quantum version of the arithmetic recursion presented above. The desired assertion for D₁ follows by observing that it is a literal inverse of E₁. In both of these cases, the quantum register |R₁R₂ . . . R_{η}> always remains in the same initial state |0_{ηq>.}

This furnishes a way of implementing Eq. (12) and its inverse Eq. (14). Recall, however, that to achieve compression the invention is interested in implementing Eq. (15). The obvious strategy of first implementing Eq. (12) and simply transmitting the k most significant qubits of |C(χ)> does not work, since these k qubits are entangled with the nq-k least significant qubits of |C(χ)>. Hence, a measurement on these nq-k least significant qubits will irreversibly change the k most significant qubits. To avoid such an accident, the invention must erase the nq-k qubits. This is the central difficulty that the invention must overcome. The invention now explains the functionality of the algorithms E and D on the second set of inputs.

Suppose that a measurement on the qubit |I_{τ}> has been made, and the event {|I_{τ}>^{m}|0>} has occurred. Let |χ>, χεG_{τ}, denote any good eigenstate. The algorithms D and E, respectively, compute the following maps:

D₂:|0_{η},C(χ)_{[k]}1_{ηq-k,}0_{ηq}>−→|χ,0_{ηq},R₁R₂ . . . R_{η}> (25)

E₂:χ,0_{ηq},R₁R₂ . . . R_{η}>−→|0_{η},C(χ)_{[k]}1_{ηq-k,} 0_{η}q>. (26)

The invention establishes the assertion for D₂ in detail. The desired assertion for E₂ follows by observing that it is a literal inverse of D₂. Fix a good eigenstate |χ>=|χ₁χ₂ . . . χ_{η}>. As shown above, |χ> can be decoded to correctly; the gist of what follows is that not only may |χ> be decoded correctly, in fact, it may be decoded correctly in a sequential or recursive fashion. For a index i, i=1, 2, . . . , η, recall that |χ_{[i]}>≡|χ₁χ₂ . . . χᵢ>. The invention first shows that lines D7-D13 in FIG. 6 behave as desired. For any i=1, 2, . . . η and for real number C, observe that if

$$C ( {χ}_{[ i ]} ) \leq C < C ( {χ}_{[ i ]} ) + Λ ( {χ}_{[ i ]} ; {λ}_{0}^{⋄} , {λ}_{1}^{⋄} ) \qquad ( 27 )$$

then, after the computation in lines D7-D13, the invention has

$$C ( {χ}_{[ i - 1 ]} ) \leq C < C ( {χ}_{[ i - 1 ]} ) + Λ ( {χ}_{[ i - 1 ]} ; {λ}_{0}^{⋄} , {λ}_{1}^{⋄} )$$

However, the invention has from Eq. (19) and Eq. (20) that, if the invention sets C=C(χ)_{[k]}+Σᵢ₌ₖ₊₁^{ηq}2⁻ⁱ, then the inequality Eq. (27) holds for i=n. Hence, by induction, the inequality Eq. (27) holds for all i=1, 2, . . . , η. Step 2: The invention now shows that lines D2-D6 behave as desired. For any i=1, 2, . . . , η and for real number C, if the inequality Eq. (27) holds, then

$$C \geq {λ}_{0}^{⋄}$$

if and only if

$$C ( {χ}_{[ i ]} ) \geq {λ}_{0}^{⋄} \qquad ( 28 )$$

The “if” part of Eq. (28) follows trivially from Eq. (27). To see the “only if” part, observe that if

$$C \geq {λ}_{0}^{⋄} ,$$

then, by Eq. (27),

$$C ( {χ}_{[ i ]} ) + Λ ( {χ}_{[ i ]} ; {λ}_{0}^{⋄} , {λ}_{1}^{⋄} ) > {λ}_{0}^{⋄} .$$

Hence,

$$C ( {χ}_{[ i ]} ) > {λ}_{0}^{⋄} - Λ ( {χ}_{[ i ]} ; {λ}_{0}^{⋄} , {λ}_{1}^{⋄} ) .$$

Hence, again by Eq. (27),

$$C \geq C ( {χ}_{[ i ]} ) > {λ}_{0}^{⋄} - Λ ( {χ}_{[ i ]} ; {λ}_{0}^{⋄} , {λ}_{1}^{⋄} ) .$$

The only allowed values of C(χ_{[i]}) that satisfy the above inequality are

$$C ( {χ}_{[ i ]} ) \geq {λ}_{0}^{⋄}$$

as desired.

Observe that Eq. (25) is almost the desired decoder Eq. (18) except for the “remainder” |R₁R₂ . . . R_{η}>, which is left over. Once again, the decoded state |χ> is entangled with this remainder, and, hence, the remainder must be erased. Similarly, Eq. (26) is almost the desired encoder Eq. (15) except that it requires the above left over remainder as an input.

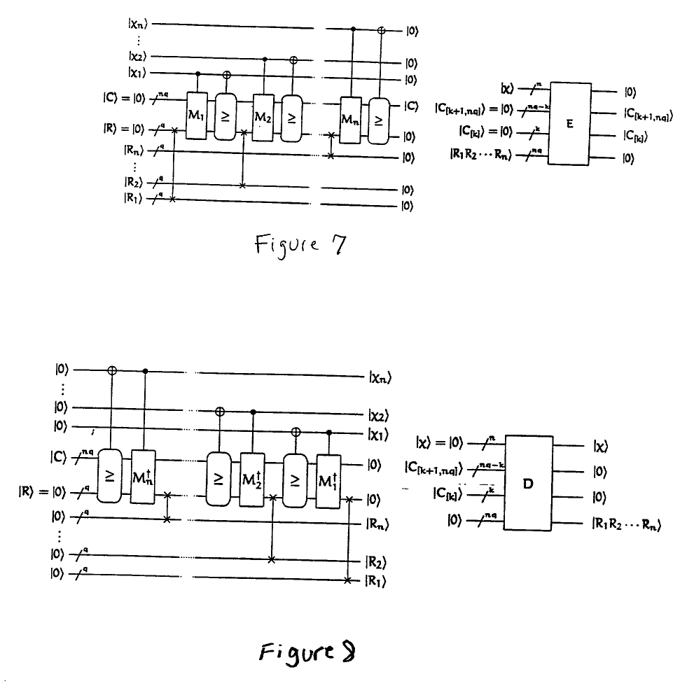

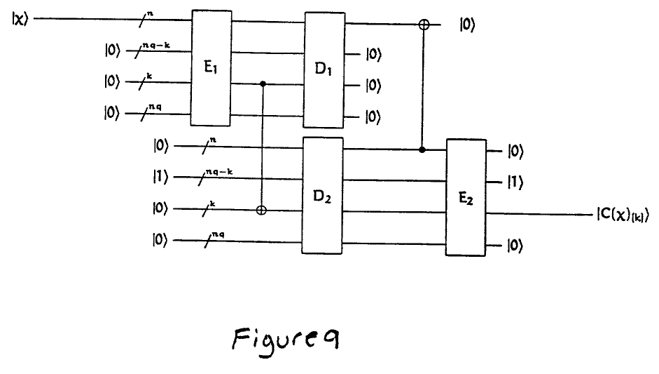

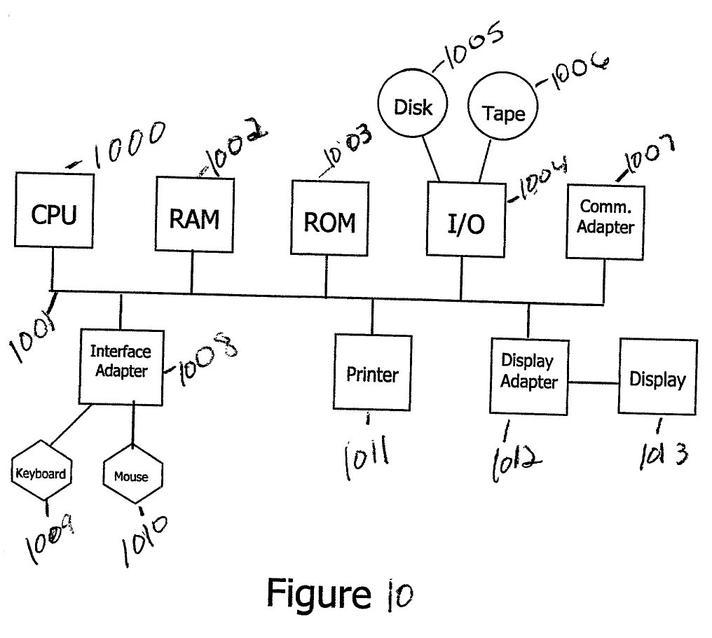

It follows from the above discussion that the algorithms described above do not, in themselves, yield either the desired encoder Eq. (15) or the decoder Eq. (18). The invention now presents an algorithm, in FIG. 9, the desired encoder. The desired decoder is obtained by literally running the encoder in reverse. The circuit in FIG. 9 is started by applying the transformation E₁E₁:|χ, 0_{ηq}, 0_{ηq}>→|0_{η}, C(χ), 0_{ηq}>.

After the k most significant qubits of |C_{(χ)}> are copied (of course, they are not truly copied in the classical sense, since qubits cannot be cloned; they are entangled with an auxiliary set of qubits prepared in the |0> state), the output of E₁ is acted upon by the transformation D₁D₁|0_{η}, C(χ), 0_{ηq}>→|χ, 0_{ηq}, 0_{ηq}>.

This has the effect of annihilating all the nq qubits of |C(χ)>. However, it recreates the input quantum state |χ> which must also be erased. Now, by employing the k copied qubits |C(χ)_{[k]}>, the invention can apply D₂D₂:|0_{η}, C(χ)_{[k]}1_{ηq-k}, 0_{ηq}>→|χ, 0_{ηq}, R₁R₂ . . . R_{η}>.

The quantum state |χ> produced at the output of D₂ is used to erase the same quantum state produced at the output of D₁. Now, by applying E₂ to the output produced by D₂, the invention has the desired output:

E₂:|χ,0_{ηq},R₁R₂ . . . R_{η}>→0_{η},C(χ)_{[k]}1_{ηq-k},0_{ηq}>.

In the end, the invention is guaranteed that no quantum register in FIG. 9 is entangled with the final output |C(χ)_{[k]}>. Hence, the output can now be freely transmitted. Observe that the cascade of E₁ and D₁ is the identity map, and, similarly, the cascade of D₂ and E₂ is also the identity map.

The invention now analyzes the complexity of implementing the E₁ block in FIG. 9. The E₁ block can be implemented using the circuit presented in FIG. 7. The “≧” operator compares a nq qubit register C to a q bit constant. Using the TEST-GREATER-THAN circuits [R. Cleve et al., supra], such comparisons can be implemented quantum-mechanically in O(nq) elementary quantum gates. The invention has used a “swap” or ←→ operator in circuits for multiply and divide. A quantum-mechanical operator that swaps two quantum registers of length q can be implemented using O(q) quantum Fredkin gates (E. Fredkin and T. Toffoli, “Conservative logic,” International Journal of Theoretical Physics, vol. 21, no. 3/4, pp. 219-253, 1982, and H. F. Chau and F. Wilczek, “Simple realization of the Fredkin gate using a series of two-body operators,” Physical Review Letters, vol. 75, no. 4, pp. 748-750, 1995, each incorporated herein by reference). For the index i, 1≦i≦n, the overall circuit for Mi can be implemented in O(i²q²) elementary quantum gates. In conclusion, the overall circuit for the E₁ block can be implemented using O(n³q²) elementary quantum gates. The blocks D₁, E₂, and D₂ have the same complexity as the block E₁. Hence, the overall encoder in FIG. 9 can also be implemented using O(n³q²) elementary quantum gates. Also, using similar reasoning, it follows that the overall encoder in FIG. 9 has a O(n²q²) computational complexity.

While the overall methodology of the invention is described above, the invention can be embodied in any number of different types of systems and executed in any number of different ways, as would be known by one ordinarily skilled in the art. For example, as illustrated in FIG. 10, a typical hardware configuration of an information handling/computer system in accordance with the invention preferably has at least one processor or central processing unit (CPU) 1000. For example, the central processing unit 1000 could include various image/texture processing units, mapping units, weighting units, classification units, clustering units, filters, adders, subtractors, comparators, etc. Alternatively, as would be known by one ordinarily skilled in the art given this disclosure, multiple specialized CPU's (or other similar individual functional units) could perform the same processing, mapping, weighting, classifying, clustering, filtering, adding, subtracting, comparing, etc.

The CPU 1000 is interconnected via a system bus 1001 to a random access memory (RAM) 1002, read-only memory (ROM) 1003, input/output (I/O) adapter 1004 (for connecting peripheral devices such as disk units 1005 and tape drives 1006 to the bus 1001), communication adapter 1007 (for connecting an information handling system to a data processing network) user interface adapter 1008 (for connecting peripherals 1009-1010 such as a keyboard, mouse, imager, microphone, speaker and/or other interface device to the bus 1001), a printer 1011, and display adapter 1012 (for connecting the bus 1001 to a display device 1013). The invention could be implemented using the structure shown in FIG. by including the inventive method, described above, within a computer program stored on the storage device 1005.

The invention has constructed a quantum algorithm for block compression of quantum information which is an analog of classical arithmetic coding. In contrast to the classical case, the quantum algorithm must take extra care to leave behind no residual traces of its past history. The algorithm thus begins by projecting the state into the typical subspace, then a sequence of encoding and decoding using finite precision arithmetic is done in a manner so as to obliterate all possible imprecisions.

Unlike the classical algorithms for arithmetic coding, the multiplication steps used in the invention's algorithm require a linearly increasing precision in the block size n. In the classical case, it is known how to implement these multiplications using precision that is independent of n [J. Rissanen et al., supra].

It is straightforward to perform this algorithm in parallel, so as to reduce the number of time-steps necessary for its circuit implementation. Multiplication and addition are known to be in NC(1), and believed to also be in the quantum counterpart to this class, so that it is possible to obtain an O(n) running time implementation of the inventions algorithm. Quantum circuits such as the one the invention presented may also find use as reversible classical circuits, which potentially require much less power for their execution when using technologies such as reversible CMOS or charge recovery logic see, (S. Younis and T. Knight, “Non dissipative rail drivers for adiabatic circuits,” in Proceedings of the Sixteenth Conference on Advanced Research in VLSI 1995 (Los Alamitos, Calif.), pp. 404-414, IEEE Comput. Soc. Press, 1995), incorporated herein by reference). Finally, the invention has considered block arithmetic codes.

While the invention has been described in terms of preferred embodiments, those skilled in the art will recognize that the invention can be practiced with modification within the spirit and scope of the appended claims.

What is claimed is:

1. A method of encoding/decoding a block of quantum data comprising:
removing trailing eigenstates from said block that have eigenvalues below a predetermined limit to retain leading eigenstates that have eigenvalues above said predetermined limit; and
encoding said remaining quantum bits retained in said block after said removing.

2. The method in claim 1, wherein said remaining quantum bits comprise a linear superposition of said leading eigenstates.

3. The method in claim 1, wherein said predetermined limit is based upon a density matrix of said block.

4. The method in claim 1, wherein said encoding produces encoded quantum bits, said method further comprising decoding said encoded quantum bits by reversing said encoding.

5. The method in claim 4, wherein said decoding reproduces said remaining quantum bits.

6. The method in claim 1, wherein said encoding completely erases said remaining quantum bits.

7. The method in claim 4, further comprising outputting only an encoded or decoded result.

8. A method for block compression of quantum information comprising:
projecting a block quantum state into a typical subspace comprising a plurality of eigenstates;
encoding said subspace using an encoder; and
decoding said subspace using a decoder.

9. The method of claim 8, further comprising:
generating said block quantum state using a quantum memoryless Bernoulli source.

10. The method of claim 8, wherein said projecting of said block quantum state into said typical subspace comprises:
analyzing a plurality of eigenvalues contained in a density matrix associated with said block quantum state;
determining a plurality of largest eigenvalues;
spanning said subspace, wherein said eigenstates are associated with said largest eigenvalues to produce a spanned subspace; and
projecting said block quantum state into said spanned subspace, to produce a projected block quantum state that lies in a low dimensional typical subspace.

11. The method of claim 8, wherein said encoder and decoder are quantum-mechanical inverses of each other; and
said decoding is achieved by performing said encoding in reverse.

12. The method of claim 11, wherein said encoding comprises using a fixed-rate quantum Shannon-Fano code to compress said projected block quantum state, wherein compression occurs at a per symbol code rate that is slightly higher than a von Neumann entropy limit.

13. The method of claim 11, wherein said encoding comprises:
creating a representation quantum Shannon-Fano code as a plurality of quantum arithmetic codes; and
using said plurality of quantum arithmetic codes to compress said subspace containing said projected block quantum state.

14. A method for block compression of quantum information comprising:
projecting a block quantum state into a typical subspace comprising a plurality of eigenstates;
encoding said subspace using an encoder.

15. The method claim 14, further comprising:
generating said block quantum state using a quantum memoryless Bernoulli source.

16. The method of claim 14, wherein said projecting of said block quantum state into said typical subspace comprises:
analyzing a plurality of eigenvalues contained in a density matrix associated with said block quantum state;
determining a plurality of largest eigenvalues;
spanning said subspace, wherein said plurality of eigenstates are associated with said largest eigenvalues to produce a spanned subspace; and
projecting said block quantum state into said spanned subspace quantum state that lies in a low dimensional typical subspace.

17. The method of claim 14, further comprising using said encoder in reverse, to decode said subspace.

18. The method of claim 16, wherein said encoding comprises using a fixed-rate quantum Shannon-Fano code to compress said projected block quantum state, wherein compression occurs at a per symbol code rate that is slightly higher than the von Neumann entropy limit.

19. The method of claim 16, wherein said encoding comprises:
creating a representation quantum Shannon-Fano code as a plurality of quantum arithmetic codes; and
using said plurality of quantum arithmetic codes to compress said subspace containing said projected block quantum state.

20. A program storage device readable by machine, tangibly embodying a program of instructions executable by the machine to perform a method for block compression of quantum information comprising:
projecting a block quantum state into a typical subspace comprising a plurality of eigenstates;
encoding said subspace using an encoder; and
decoding said subspace using a decoder.

21. A program storage device as in claim 20, further comprising:
generating said block quantum state using a quantum memoryless Bernoulli source.

22. A program storage device as in claim 20 wherein said projecting of said block quantum state into said typical subspace comprises:
analyzing a plurality of eigenvalues contained in a density matrix associated with said block quantum state;
determining a plurality of largest eigenvalues;
spanning said subspace, wherein said eigenstates are associated with said largest eigenvalues to produce a spanned subspace; and
projecting said block quantum state into said spanned subspace, to produce a projected block quantum state that lies in a low dimensional typical subspace.

23. A program storage device as in claim 20, wherein said encoder and decoder are quantum-mechanical inverses of each other; and
said decoding is achieved by performing said encoding in reverse.

24. A program storage device as in claim 23, wherein said encoding comprises using a fixed-rate quantum Shannon-Fano code to compress said projected block quantum state, wherein compression occurs at a per symbol code rate that is slightly higher than a von Neumann entropy limit.

25. A program storage device as in claim 23, wherein said encoding comprises:
creating a representation quantum Shannon-Fano code as a plurality of quantum arithmetic codes; and
using said plurality of quantum arithmetic codes to compress said subspace containing said projected block quantum state.
